(19) United States
(12) Patent Application Publication
(10) Pub. No.: US 2018/0056264 A1
(43) Pub. Date: Mar. 1, 2018

(54) ULTRA LOW PRESSURE CONTINUOUS CATALYST TRANSFER WITHOUT LOCK HOPPER

(71) Applicant: UOP LLC, Des Plaines, IL (US)

(72) Inventors: Richard Gaicki, Chicago, IL (US); Rajeswar Gattupalli, Buffalo Grove, IL (US); Charles Brabson, Humble, TX (US); Kyle P. Austin, Algonquin, IL (US); Christopher Naunheimer, Arlington Heights, IL (US); Michael J. Vetter, Schaumburg, IL (US)

(21) Appl. No.: 15/798,331

(22) Filed: Oct. 30, 2017

Related U.S. Application Data
(63) Continuation of application No. PCT/US2016/037151, filed on Jun. 13, 2016.
(60) Provisional application No. 62/183,943, filed on Jun. 24, 2015.

(51) Int. Cl. B01J 8/00

(52) U.S. Cl. CPC B01J 8/0025; B01J 2208/00761; B01J 8/0035

(57) ABSTRACT

An apparatus is presented for the transferring of catalyst from an upstream vessel to a downstream vessel. The apparatus includes a non-mechanical valve and a transfer line, wherein a lift gas provides for carrying catalyst through the transfer line. The non-mechanical valve has a catalyst inlet and a lift gas inlet to provide for a consistent flow to limit or reduce pipe erosion and catalyst attrition, as well as to provide catalyst and lift gas to the transfer lines.

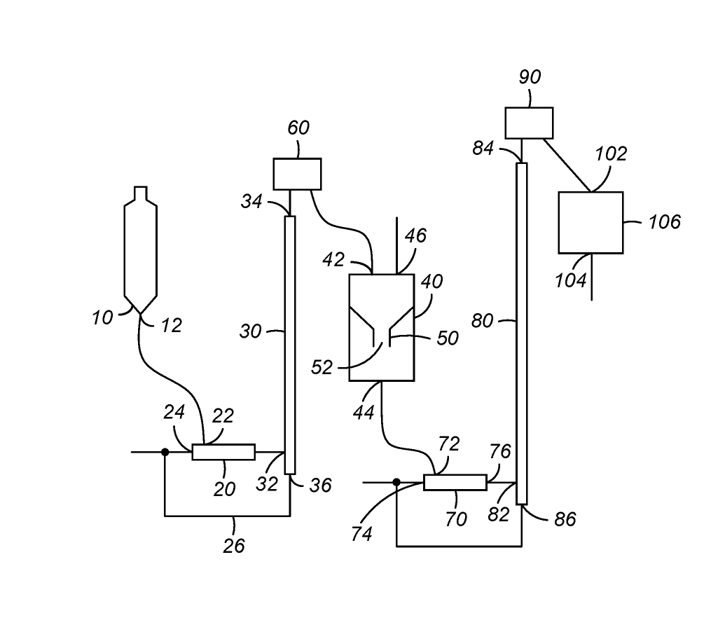

### CROSS-REFERENCE TO RELATED APPLICATIONS

This application is a Continuation of copending International Application No. PCT/US2016/037151 filed Jun. 13, 2016 which application claims benefit of U.S. Provisional Application No. 62/183,943 filed Jun. 24, 2015, now expired, the contents of which cited applications are hereby incorporated by reference in their entirety.

### FIELD OF THE INVENTION

The present invention relates to solids transfer equipment. In particular, the invention is directed to the low pressure transfer of catalyst particles between reactors, or a reactor and a regenerator.

### BACKGROUND

Many modern chemical processes utilize catalysts for the conversion of a feedstock to a more valuable product stream. Catalysts have a limited life of operation before a need for the regeneration of the catalyst. In many chemical operations, the process involves passing a catalyst between a reactor to a regenerator and back again to provide for a long continuous operation.

However, a continuous catalyst regeneration technology in use today does not provide for a continuous constant rate of catalyst circulation. The process today involves the use of lock hoppers and lift engagers to circulate catalyst in small batches to provide for a semi-continuous process. This batch-wise catalyst transfer process can lead to catalyst bridging and the plugging of catalyst transfer lines.

There is a need to improve the process and equipment for the transfer of catalyst in a continuous catalyst regeneration system.

### SUMMARY

The present invention serves to reduce catalyst attrition and reduce catalyst plugging in the paraffin dehydrogenation process in a process that has a very low source and destination pressure. This is unique and different than what is done in all current technologies.

A first embodiment of the invention is an apparatus for the transfer of catalyst comprising a first vessel from a terminal reactor having an inlet and an outlet; a non-mechanical valve having a catalyst inlet in fluid communication with the first vessel outlet, a lift gas inlet, and an outlet; a transfer line having an inlet in fluid communication with the non-mechanical valve outlet, and an outlet; a first downstream vessel having an inlet in fluid communication with the transfer line, and a gas outlet and a catalyst outlet, wherein first downstream vessel includes an internal pipe and a restriction orifice; and a second downstream having an inlet in fluid communication with the first downstream vessel outlet, and an outlet. An embodiment of the invention is one, any or all of prior embodiments in this paragraph up through the first embodiment in this paragraph further comprising an impactless elbow disposed in the transfer line and at a position in the transfer line at an elevated position relative to the catalyst disengaging drum. An embodiment of the invention is one, any or all of prior embodiments in this paragraph up through the first embodiment in this paragraph wherein the transfer line further includes a second inlet for admitting a second lift gas stream. An embodiment of the invention is one, any or all of prior embodiments in this paragraph up through the first embodiment in this paragraph wherein the second inlet is in a position in the transfer line disposed below the inlet form the non-mechanical valve outlet. An embodiment of the invention is one, any or all of prior embodiments in this paragraph up through the first embodiment in this paragraph further comprising a second non-mechanical valve having an inlet in fluid communication with the first downstream vessel outlet, a lift gas inlet and an outlet. An embodiment of the invention is one, any or all of prior embodiments in this paragraph up through the first embodiment in this paragraph further comprising a second transfer line having an inlet in fluid communication with the second non-mechanical valve outlet, and an outlet. An embodiment of the invention is one, any or all of prior embodiments in this paragraph up through the first embodiment in this paragraph further comprising a second impactless elbow disposed in the second transfer line and at a position in the transfer line at an elevated position relative to a third downstream vessel. An embodiment of the invention is one, any or all of prior embodiments in this paragraph up through the first embodiment in this paragraph wherein the second transfer line further includes a second inlet for admitting a second lift gas stream. An embodiment of the invention is one, any or all of prior embodiments in this paragraph up through the first embodiment in this paragraph wherein the second inlet is in a position in the second transfer line disposed below the inlet from the second non-mechanical valve outlet. An embodiment of the invention is one, any or all of prior embodiments in this paragraph up through the first embodiment in this paragraph wherein the non-mechanical valve comprises a horizontal length of pipe having a first inlet for admitting catalyst particles, a second inlet for admitting a lift gas, and an outlet.

A second embodiment of the invention is an apparatus for the transfer of catalyst from a reactor to a regenerator, comprising a first vessel from a terminal reactor having an inlet and an outlet; a first non-mechanical valve having a catalyst inlet in fluid communication with the first vessel outlet, a lift gas inlet, and an outlet; a first transfer line having an inlet in fluid communication with the first non-mechanical valve outlet, and an outlet; a first downstream vessel having an inlet in fluid communication with the transfer line, and a gas outlet and a catalyst outlet, wherein the first downstream vessel includes an internal standpipe and a restriction orifice; a second non-mechanical valve having an inlet in fluid communication with the first downstream vessel outlet, a lift gas inlet and an outlet; and a second transfer line having an inlet in fluid communication with the second non-mechanical valve outlet and an outlet in fluid communication with a third downstream vessel. An embodiment of the invention is one, any or all of prior embodiments in this paragraph up through the second embodiment in this paragraph wherein the first transfer line further includes a second inlet for admitting a second lift gas. An embodiment of the invention is one, any or all of prior embodiments in this paragraph up through the second embodiment in this paragraph wherein the second inlet is in a position in the first transfer line disposed below the inlet from the first non-mechanical valve outlet. An embodiment of the invention is one, any or all of prior embodiments in this paragraph up through the second embodiment in this paragraph wherein the non-mechanical valve comprises a horizontal length of pipe having a first inlet for admitting catalyst particles, a second inlet for admitting a lift gas, and an outlet. An embodiment of the invention is one, any or all of prior embodiments in this paragraph up through the second embodiment in this paragraph wherein the second transfer line further includes a second inlet for admitting a second lift gas. An embodiment of the invention is one, any or all of prior embodiments in this paragraph up through the second embodiment in this paragraph wherein the second inlet is in a position in the second transfer line disposed below the inlet from the second non-mechanical valve outlet.

A third embodiment of the invention is a process for transferring catalyst from a reactor to another reactor, comprising passing catalyst from a first vessel to a non-mechanical valve; passing a lift gas to the non-mechanical valve to carry the catalyst to a transfer line; passing a lift gas to the transfer line to lift the catalyst up the transfer line; and passing the lifted catalyst to a first downstream vessel; wherein the pressure at the inlet to the non-mechanical valve is at least 10 kPa (gauge). An embodiment of the invention is one, any or all of prior embodiments in this paragraph up through the third embodiment in this paragraph wherein the pressure at the inlet to the non-mechanical valve is at least 7 kPa (gauge). An embodiment of the invention is one, any or all of prior embodiments in this paragraph up through the third embodiment in this paragraph wherein the pressure at the inlet to the non-mechanical valve is at least 4 kPa (gauge). An embodiment of the invention is one, any or all of prior embodiments in this paragraph up through the third embodiment in this paragraph wherein the lift gas comprises nitrogen.

Other objects, advantages and applications of the present invention will become apparent to those skilled in the art from the following detailed description and drawing.

### BRIEF DESCRIPTION OF THE DRAWING

The FIGURE is a schematic of the apparatus of the present invention.

### DETAILED DESCRIPTION

In a current olefin conversion process, a continuous catalyst regeneration (CCR) technology is used the utilizes a batch-wise transfer system, wherein small amounts of catalyst are collected and then transferred. This utilizes equipment, such as lock hoppers and lift engagers and complex valving for the transfer of catalyst from a reactor to a regenerator. The transfer of catalyst through this equipment is subject to catalyst plugging of transfer lines and valves, and the attrition of the catalyst as the catalyst is eroded in the transfer process.

The present invention allows for a reduced catalyst plugging and reduced catalyst attrition. The apparatus also provides for a continuous flow to a catalyst regenerator for consistent flow of catalyst to the regenerator. In particular, in the current Oleflex' technology, catalyst flows from the annular space between the Oleflex reactor screens through a series of catalyst transfer pipes into an external catalyst collector. From the catalyst collector, the catalyst then flows into a lift engager, where the catalyst batch is lifted into the top of the next reactor. In the final Oleflex reactor, a lock hopper is located between the catalyst collector and a lift engager; the lock hopper is used to change catalyst atmospheres from hydrogen/hydrocarbon environment to a nitrogen environment so that the catalyst can be safely regenerated. Similarly, in the catalyst lift from the CCR regenerator to the first Oleflex reactor, a lock hopper is used upstream of the lift engager to change from a nitrogen atmosphere to a hydrogen atmosphere before the catalyst enters the first reactor.

The batch lifting of catalyst through the system necessitates the use of higher catalyst velocities that would be required for constant-rate catalyst circulation. In addition, the complex valving required for the lock hoppers and lift engagers coupled with the higher catalyst velocity result in increased catalyst attrition rates.

The present invention is an apparatus for the transfer of catalyst. The apparatus, as shown in the FIGURE, includes a first vessel 10 from a terminal reactor having an inlet and an outlet 12. The apparatus includes a non-mechanical valve 20 having a catalyst inlet 22 in fluid communication with the first vessel outlet 12, a lift gas inlet 24 and an outlet 26 for the exit of a gas-catalyst mixture. The apparatus further includes a transfer line 30 having an inlet 32 in fluid communication with the non-mechanical valve outlet 26 and an outlet 34. The apparatus further includes a first downstream vessel 40 having an inlet 42 in fluid communication with the transfer line outlet 34 and an outlet 44. The first downstream vessel 40 includes a gas outlet 44, and an internal pipe 50 with a restriction orifice 52. The internal pipe 50 has a diameter that is large enough for the free flow of catalyst, and narrower than the first downstream vessel diameter. A preferred pipe diameter is less than one third of the diameter of the downstream vessel. The restriction orifice is for controlling the flow of catalyst in the pipe, and has an opening that is less than or equal to the pipe diameter. In one embodiment, the pipe can act as the restriction orifice with an appropriately sized pipe.

The apparatus can further include an impactless elbow 60 disposed at the transfer line outlet 34 and in fluid communication with the transfer line outlet 34 and the first downstream vessel inlet 42. An impactless elbow is a device for receiving a flowing fluid carrying solid particles, and has an expanded diameter to allow the fluid to slow and have the particles slow down or even settle out without having to impact the walls of the device. An impactless elbow can be a pipe with an enlarged diameter and curved to redirect the flow without having the catalyst particles impinging on the walls of the elbow. This reduces attrition of the catalyst.

The transfer line 30 can include a second inlet 36 for admitting additional lift gas. The transfer line has a vertical orientation with the outlet 34 at an elevation above the inlet 32. The second inlet 36 is disposed at an elevation below the inlet 32.

In one embodiment, the apparatus can include a second non-mechanical valve 70 having an inlet 72 in fluid communication with the first downstream vessel outlet 44. The second non-mechanical valve includes a lift gas inlet 74 and an outlet 76 for carrying the lift gas and catalyst. This embodiment includes a second transfer line 80 having an inlet 82 in fluid communication with the second non-mechanical valve outlet 76 and a transfer line outlet 84.

The second transfer line can include a second inlet 86 for admitting additional lift gas, wherein the second inlet 86 is disposed at a lower elevation than the inlet 82 to the transfer line. This embodiment also includes a second impactless elbow 90 having an inlet 92 in fluid communication with the second transfer line outlet 84, and disposed in an elevated position above the second transfer line 80.

In one embodiment, a second downstream vessel 100 can have an inlet 102 in fluid communication with the second transfer line outlet 84 and an outlet 104 that is in fluid communication with a catalyst regenerator (not shown). The apparatus can further includes a second impactless elbow 90 disposed at the second transfer line outlet 84 and in fluid communication with the transfer line outlet 84 and the second downstream vessel inlet 102. The second downstream vessel is a disengaging hopper for more consistently feeding catalyst to the catalyst regenerator.

The non-mechanical valve 20, 70 is a system for transferring a flowing solid with a fluid. The valve comprises a horizontal length of conduit, or piping, having an inlet for the solid particles to be carried in, and a second inlet for a fluid to carry the particles. The fluid can be a lifting gas. The conduit includes an outlet for the flowing fluid with the particles. The outlet to the non-mechanical valve carries the flowing fluid with the particles to a transfer line 30, 80, wherein the particles are transferred to an elevated position and allowed to flow by gravity to a receiving vessel.

A lift gas will be a non-oxidizing gas, and a preferred lift gas is nitrogen.

The process involves withdrawing catalyst from the terminal reactor in a series of reactors. The catalyst is withdrawn at a pressure of approximately 4 kPa (gauge). The catalyst is passed to the disengaging hopper of the CCR regenerator which is at approximately 5 kPa (gauge). The catalyst flows down from a catalyst collector to the L-valve, or non-mechanical valve, which is a pressure control point at a pressure of at least 20 kPa higher than the catalyst collector. This pressure difference is to ensure there is a high lift gas bubble to prevent hydrocarbons from leaking into the L-valve and into the regenerator tower. The catalyst will be lifted to an intermediate disengaging hopper. Based upon operation the lift line difference in pressure can range from 21 kPa (gauge) during circulation of catalyst lifting to 7 kPa (gauge) during catalyst non-lifting. This will cause the pressure in the disengaging hopper to range from 3.5 kPa (gauge) to 18 kPa (gauge). The difference of pressure will be taken over the internal standpipe and restriction orifice within the disengaging vessel.

While the invention has been described with what are presently considered the preferred embodiments, it is to be understood that the invention is not limited to the disclosed embodiments, but it is intended to cover various modifications and equivalent arrangements included within the scope of the appended claims.

What is claimed is:

1. An apparatus for the transfer of catalyst comprising:
a non-mechanical valve having a catalyst inlet, a lift gas inlet, and an outlet;
a transfer line having an inlet in fluid communication with the non-mechanical valve outlet, and an outlet;
a first downstream vessel having an inlet in fluid communication with the transfer line, and a gas outlet and a catalyst outlet, wherein first downstream vessel includes an internal pipe and a restriction orifice.

2. The apparatus of claim 1 further comprising an impactless elbow disposed in the transfer line and at a position in the transfer line at an elevated position relative to the catalyst disengaging drum.

3. The apparatus of claim 1 wherein the transfer line further includes a second inlet for admitting a second lift gas.

4. The apparatus of claim 3 wherein the second inlet is in a position in the transfer line disposed below the inlet from the non-mechanical valve outlet.

5. The apparatus of claim 1 further comprising a second non-mechanical valve having an inlet in fluid communication with the first downstream vessel outlet, a lift gas inlet and an outlet.

6. The apparatus of claim 5 further comprising a second transfer line having an inlet in fluid communication with the second non-mechanical valve outlet, and an outlet.

7. The apparatus of claim 6 further comprising a second impactless elbow disposed in the second transfer line and at a position in the transfer line at an elevated position relative to a third downstream vessel.

8. The apparatus of claim 5 wherein the second transfer line further includes a second inlet for admitting a second lift gas.

9. The apparatus of claim 8 wherein the second inlet is in a position in the second transfer line disposed below the inlet from the second non-mechanical valve outlet.

10. The apparatus of claim 1 wherein the non-mechanical valve comprises:
a horizontal length of pipe having a first inlet for admitting catalyst particles, a second inlet for admitting a lift gas, and an outlet.

11. The apparatus of claim 1 further comprising a first vessel from a terminal reactor having an inlet in fluid communication with a terminal reactor outlet and an outlet in fluid communication with the non-mechanical valve catalyst inlet.

12. The apparatus of claim 1 further comprising a second downstream vessel having an inlet in fluid communication with the second transfer line outlet and an outlet.

13. An apparatus for the transfer of catalyst from a reactor to a regenerator, comprising:
a first vessel from a terminal reactor having an inlet and an outlet;
a first non-mechanical valve having a catalyst inlet in fluid communication with the first vessel outlet, a lift gas inlet, and an outlet;
a first transfer line having an inlet in fluid communication with the first non-mechanical valve outlet, and an outlet;
a first downstream vessel having an inlet in fluid communication with the transfer line, and a gas outlet and a catalyst outlet, wherein the first downstream vessel includes an internal standpipe and a restriction orifice;
a second non-mechanical valve having an inlet in fluid communication with the first downstream vessel outlet, a lift gas inlet and an outlet; and
a second transfer line having an inlet in fluid communication with the second non-mechanical valve outlet and an outlet in fluid communication with a third downstream vessel.

14. The apparatus of claim 13 wherein the first transfer line further includes a second inlet for admitting a second lift gas.

15. The apparatus of claim 14 wherein the second inlet is in a position in the first transfer line disposed below the inlet from the first non-mechanical valve outlet.

16. The apparatus of claim 13 wherein the non-mechanical valve comprises:
a horizontal length of pipe having a first inlet for admitting catalyst particles, a second inlet for admitting a lift gas, and an outlet.

17. The apparatus of claim 13 wherein the second transfer line further includes a second inlet for admitting a second lift gas.

18. The apparatus of claim 17 wherein the second inlet is in a position in the second transfer line disposed below the inlet from the second non-mechanical valve outlet.

19. A process for transferring catalyst from a reactor to another reactor, comprising:
passing catalyst from a first vessel to a non-mechanical valve;
passing a lift gas to the non-mechanical valve to carry the catalyst to a transfer line;
passing a lift gas to the transfer line to lift the catalyst up the transfer line; and
passing the lifted catalyst to a first downstream vessel;
wherein the pressure at the inlet to the non-mechanical valve is at least 10 kPa (gauge).

20. The process of claim 19 wherein the lift gas comprises hydrogen.
